(19) United States
(12) Patent Application Publication
(10) Pub. No.: US 2022/0122560 A1
(43) Pub. Date: Apr. 21, 2022

(54) DISPLAY DEVICE AND ELECTRONIC DEVICE

(71) Applicant: TLC CHINA STAR OPTOELECTRONICS TECHNOLOGY CO., LTD., Shenzhen, Guangdong (CN)

(72) Inventor: XIAOLI FU, Shenzhen, Guangdong (CN)

(73) Assignee: TLC CHINA STAR OPTOELECTRONICS TECHNOLOGY CO., LTD., Shenzhen, Guangdong (CN)

(21) Appl. No.: 16/766,739

(22) PCT Filed: Apr. 22, 2020
(86) PCT No.: PCT/CN2020/086062

§ 371 Date: May 25, 2020

(30) Foreign Application Priority Data
Apr. 10, 2020 (CN) 202010277074.5

(51) Int. Cl. G09G 3/36

(52) U.S. Cl. CPC G09G 3/3696; G09G 2300/0408; G09G 3/3677; G09G 3/3688

(57) ABSTRACT

A display device is provided. The display device includes a display panel and a driver circuit, in which the driver circuit includes: a data driving chip, a control chip, and a control unit. The control unit receives a common electrode voltage and is electrically connected to the control chip and a plurality of data signal output ends of the data driving chip. The control unit is configured to output the common electrode voltage to the plurality of data signal output ends under a control of a control signal outputted by the control chip when the display device is powered off.

### BACKGROUND OF INVENTION

### Field of Invention

The present invention relates to the field of display technology, and more particularly, to a display device and an electronic device.

### Description of Prior Art

Liquid crystal displays (LCDs) are not only light, thin, and small, but also have advantages of low power consumption, no radiation, and relatively low manufacturing costs, and thus dominate the field of display. Liquid crystal displays generally comprise display panels and display devices, in which the display panels comprise two substrates and a liquid crystal layer disposed between the two substrates. A state of the liquid crystal layer is adjusted by a level of an electric field applied to the liquid crystal layer by the display devices, so as to adjust transmission of light for displaying images. However, during shutdown of the liquid crystal displays, power off speed of data signals outputted from data driving chips is significantly faster than that of common electrode voltage signals, such that large voltage differences between the data signals and the common voltage signals at both ends of liquid crystal molecules occur, and the display panels flash white.

### SUMMARY OF INVENTION

The technical problem to be solved by the present invention is that during the shutdown of the liquid crystal displays, the power off speed of data signals outputted from the data driving chips is significantly faster than that of common electrode voltage signals, such that large voltage differences between the data signal and the common voltage signal at both ends of the liquid crystal molecules occur, and the display panels is flashing white.

The embodiments of the present invention provide a display device and an electronic device, so as to solve the technical problem that display panels flash white during the shutdown of display devices.

The present invention provides a display device which is configured to drive a display panel. The display device comprises:
a data driving chip, which has a plurality of data signal output ends, and is configured to output a data signal to the display panel through the plurality of data signal output ends;
a control chip, which is configured to output a control signal when the display device is powered off; and
a control unit, which has a control end, an input end, and a plurality of output ends, in which the control end is electrically connected to the control chip, the input end receives a common electrode voltage, and each of the output ends is connected to each of the data signal output ends.

The control unit is configured to output the common electrode voltage to the plurality of data signal output ends under a control of the control signal when the display device is powered off.

In the display device provided in the present invention, the control unit comprises a plurality of transistors, in which each of the transistors is connected to each of the data signal output ends, a gate of each of the transistors is connected to the control end, a source of each of the transistors is connected to each of the data signal output ends, and a drain of each of the transistors is connected to the input end.

In the display device provided in the present invention, all of the transistors are transistors of the same type.

In the display device provided in the present invention, the display device has a normal display mode and a power-off mode.

When the display device is under the normal display mode, the plurality of transistors are all turned off, and the data driving chip outputs the data signal to the display panel through the plurality of data signal output ends.

When the display device is under the power-off mode, the plurality of transistors are all turned on, and the common electrode voltage is outputted to the plurality of data signal output ends.

In the display device provided in the present invention, the display panel comprises a plurality of data lines, and each of the data lines is connected to each of the data signal output ends.

In the display device provided in the present invention, the display panel further comprises a plurality of scanning lines, and the plurality of scanning lines and the plurality of data lines intersect each other to define a plurality of pixel unit. Each of the pixel units is electrically connected to a common electrode, and the common electrode is electrically connected to the input end.

In the display device provided in the present invention, the control unit is integrated in the data driving chip.

In the display device provided in the present invention, the display device further comprises a chip on film, in which an end of the chip on film is connected to the display panel, and the data driving chip and the control unit are disposed on the chip on film.

In the display device provided in the present invention, the display device further comprises a circuit board, in which the other of the chip on film is connected to the circuit board, and the control chip is disposed on the circuit board.

Additionally, the embodiments of the present invention further provide an electronic device, comprising a display device. The display device comprises a display panel and a driver circuit, in which the driver circuit is configured to drive the display panel and comprises:
a data driving chip, which has a plurality of data signal output ends, and is configured to output a data signal to the display panel through the plurality of data signal output ends;
a control chip, which is configured to output a control signal when the display device is powered off; and
a control unit, which has a control end, an input end, and a plurality of output ends, in which the control end is electrically connected to the control chip, the input end receives a common electrode voltage, and each of the output ends is connected to each of the data signal output ends.

The control unit is configured to output the common electrode voltage to the plurality of data signal output ends under a control of the control signal when the display device is powered off.

In the electronic device provided in the present invention, the control unit comprises a plurality of transistors, in which each of the transistors is connected to each of the data signal output ends, a gate of each of the transistors is connected to the control end, a source of each of the transistors is connected to each of the data signal output ends, and a drain of each of the transistors is connected to the input end.

In the electronic device provided in the present invention, all of the transistors are transistors of the same type.

In the electronic device provided in the present invention, the display device has a normal display mode and a power-off mode.

When the display device is under the normal display mode, the plurality of transistors are all turned off, and the data driving chip outputs the data signal to the display panel through the plurality of data signal output ends.

When the display device is under the power-off mode, the plurality of transistors are all turned on, and the common electrode voltage is outputted to the plurality of data signal output ends.

In the electronic device provided in the present invention, the display panel comprises a plurality of data lines, and each of the data lines is connected to each of the data signal output ends.

In the electronic device provided in the present invention, the display panel further comprises a plurality of scanning lines, and the plurality of scanning lines and the plurality of data lines intersect each other to define a plurality of pixel units. Each of the pixel units is electrically connected to a common electrode, and the common electrode is electrically connected to the input end.

In the electronic device provided in the present invention, the control unit is integrated in the data driving chip.

In the electronic device provided in the present invention, the display device further comprises a chip on film, in which an end of the chip on film is connected to the display panel, and the data driving chip and the control unit are disposed on the chip on film.

In the electronic device provided in the present invention, the display device further comprises a circuit board, in which the other end of the chip on film is connected to the circuit board, and the control chip is disposed on the circuit board.

The present invention provides a display device. During the shutdown of the display device, the control chip output a control signal, and under the control of the control signal, the control unit connects a common electrode voltage to the data signal output end, such that the data signal outputted from the data signal output end and the common electrode voltage have the same power off tendency. Accordingly, there is no voltage difference at both ends of the liquid crystal molecules, since the different power off tendency between the data signal and the common voltage signal is eliminated. Therefore, the problem that the display panel flashes white during the shutdown of the display device may be effectively prevented.

### BRIEF DESCRIPTION OF DRAWINGS

In order to more clearly illustrate the technical solutions in the embodiments or in the prior art, the drawings described in the description of the embodiments or the prior art are briefly described below. It is obvious that the drawings in the following description are only some embodiments of the present invention. Other drawings can also be obtained from those skilled persons in the art based on drawings without any creative effort.

FIG. 1 is a schematic view of a first structure of a display device according to one embodiment of the present invention.

FIG. 2 is a schematic view of a structure of a display panel of FIG. 1.

FIG. 3 is a time sequence diagram of the display device according to one embodiment of the present invention.

FIG. 4 is a schematic view of a second structure of the display device according to one embodiment of the present invention.

FIG. 5 is a schematic view of a third structure of the display device according to one embodiment of the present invention.

FIG. 6 is a schematic view of a fourth structure of the display device according to one embodiment of the present invention.

### DETAILED DESCRIPTION OF PREFERRED EMBODIMENTS

The technical solutions in the embodiments of the present invention are clearly illustrated in the following description with reference to the accompanying drawings of the embodiments of the present invention. It is obvious that the described embodiments are only a part of the embodiments of the present invention, rather than all of the embodiments. According to the embodiments of the present invention, the other embodiments obtained by a person skilled in the art without any creative effort fall within the scope of the present invention.

In the description of the present invention, it is to be understood that the terms such as “first” and “second” are merely used for descriptive purposes, rather than indicating or implying the relative importance or the number of the referred technical features. Furthermore, a feature defined by “first” or “second” may indicate or imply that one or more features are included. In the description of the present invention, “a plurality” means that the number is two or more than two, unless specifically defined otherwise.

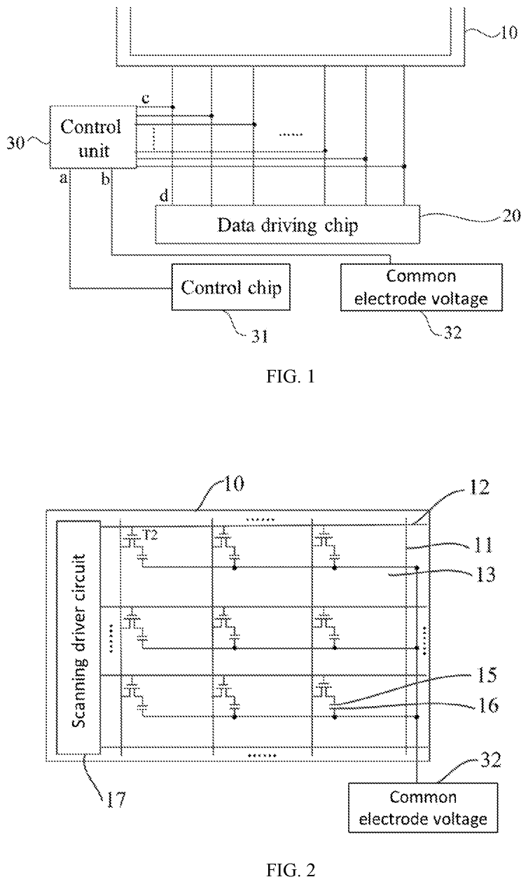

Referring to FIG. 1, the embodiment of the present invention provides a display device, which comprises a display panel 10 and a driver circuit. The driver circuit is configured to drive the display panel 10. The driver circuit comprises:
a data driving chip 20, which has a plurality of data signal output ends d, and is configured to output a data signal to the display panel 10 through the plurality of data signal output ends d;
a control chip 31, which is configured to output a control signal when the display panel 10 is powered off; and
a control unit 30, which has a control end a, an input end b, and a plurality of output ends c, in which the control end a is electrically connected to the control chip 31, the input end b receives a common electrode voltage 32, and each of the output ends c is connected to each of the data signal output ends d.

The control unit 30 is configured to output the common electrode voltage 32 to the plurality of data signal output ends d under a control of the control signal when the display device is powered off.

Specifically, referring to FIG. 1 and FIG. 2, in the display panel 10, a plurality of vertical data lines 11 are disposed and arranged parallel to each other, a plurality of horizontal scanning lines 12 are disposed and arranged parallel to each other, a plurality of pixel electrodes 15 are disposed, and a common electrode 16 is disposed opposite to the pixel electrode 15. Each of the data lines 11 is connected to each of the data signal output ends d. The data line 11 is configured to output the data signal provided by the data driving chip 20 to the display panel 10. The scanning line 12 is configured to output a scanning signal provided by a scanning driver circuit 17 to the display panel 10. The plurality of data lines 11 and the plurality of scanning lines 12 intersect each other to define a plurality of pixel units 13. Each of the pixel units 13 is electrically connected to the common electrode 16. The common electrode 16 is connected to the common electrode voltage 32.

A plurality of thin film transistors T2 are formed at the intersection of the data line 11 and the scanning line 12. A gate of the thin film transistor T2 is connected to the scanning line 12. A source of the thin film transistor T2 is connected to the data line 11. A drain of the thin film transistor T2 is connected to the pixel electrode 15. When the thin film transistor T2 is turned on, the data signal outputted from the data driving chip 20 through the data output end d is loaded on the source of the thin film transistor T2, and then transmitted to the pixel electrode 15 through the drain. In addition, the common electrode 16 is connected to the common electrode voltage 32, and thus an electric field is generated between the pixel electrode 15 and the common electrode 16 to control a rotation of liquid crystal molecules, thereby causing the display panel 10 to display images.

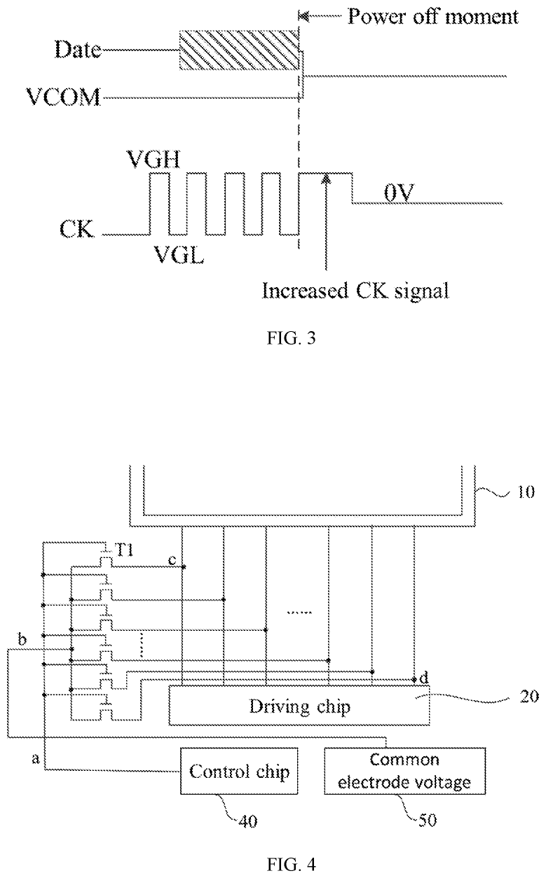

Furthermore, referring to FIG. 3, at the moment when the display device is powered off, the control unit 30 connects the common electrode voltage 32 (VCOM) to the data signal output end d under the control of the control signal, such that the data signal (Date) outputted from the data signal output end d and the common electrode voltage 32 have the same power off tendency. In this case, even if a CK signal outputted from the scanning driver circuit 17 is an on-voltage VGH to make the thin film transistor T2 in the display panel 10 be in an on state, there is no pinch between the data signal and the common electrode voltage 32, such that electricity leakage will not occur in the display panel 10. Accordingly, the problem that the display panel 10 flashes white during the shutdown of the display device may be effectively prevented.

In addition, the control chip 31 may be a timing controller (TCON). The timing controller is configured to output the control signal to the control unit 30. The control signal may be a high-level signal or a low-level signal, which may be selected based on the structure of the internal circuit of the control unit 30, and is not limited herein.

It should be understood that the display device has a normal display mode and a power-off mode. Specifically, when the display device is under the normal display mode, the control unit 30 in an off state. At this time, the data driving chip 20 outputs the data signal to the display panel 10 through the plurality of data signal output ends d, such that the screen display may be performed on the display panel 10. When the display device is under the power-off mode, the control unit 30 is in an on state. At this time, the common electrode voltage 32 is outputted to the plurality of data signal output ends d, such that the data signal of the data signal output end d and the common electrode voltage 32 have the same power off tendency.

The embodiments of the present invention provide a display device. During the shutdown of the display device, the control chip 31 outputs a control signal, and the control unit 30 connects the common electrode voltage 32 to the data signal output end d under the control of the control signal, such that the data signal of the data signal output end and the common electrode voltage have the same power off tendency. Accordingly, there is no voltage difference at both ends of the liquid crystal molecules, since the different power off tendency between the data signal and the common voltage signal is eliminated. Therefore, the problem that the display panel 10 flashes white during the shutdown of the display device may be effectively prevented.

Referring to FIG. 4, in one embodiment of the present invention, the control unit 30 comprises a plurality of transistors T1. Each of the transistors T1 is connected to each of the data signal output ends d. A gate of each of the transistors T1 is connected to the control end a, a source of each of the transistors T1 is connected to each of the data signal output ends d, and a drain of each of the transistors T1 is connected to the input end b.

Specifically, the plurality of transistors T1 used in the embodiment of the present invention may be a thin film transistor, a field effect transistor, or other elements with the same characteristics. Since the source and the drain of the transistor T1 used herein are symmetrical, the source and the drain are interchangeable. In order to distinguish the two electrodes of the transistor T1 except the gate in the embodiments of the present invention, one of the electrodes is called as a source, and the other electrode is called as a drain. According to the configuration in FIG. 3, the intermediate end of the transistor T1 is a gate, the input end is a drain, and the output end is a source. In addition, the transistor T1 used in the embodiment of the present invention may be an N-type transistor or a P-type transistor. The N-type transistor is turned on when the gate is at a high level, and is turned off when the gate is at a low level, while the P-type transistor is turned on when the gate is at a low level gate, and is turned off when the gate is at a high level.

In one embodiment of the present invention, the plurality of transistors T1 are transistors of the same type. Hence, since the plurality of transistors T1 formed between the data signal output end d of the data driving chip 20 and the display panel 10 are the same type, the process is simplified and the productivity is effectively saved. It should be understood that this embodiment of the present invention is not limited to the present invention.

In one embodiment of the present invention, an example is described in which all of the plurality of first transistors T1 are N-type transistors. When the plurality of transistors T1 are turned on, the common electrode voltage 32 is connected to the plurality of data signal output ends d through the transistors T1, such that the data signal of the data signal output end d and the common electrode voltage 32 have the same power off tendency. When the plurality of transistors T1 are turned off, the data driving chip 20 outputs the data signal to the display panel 10 through the plurality of data signal output ends d, so as to perform the screen display.

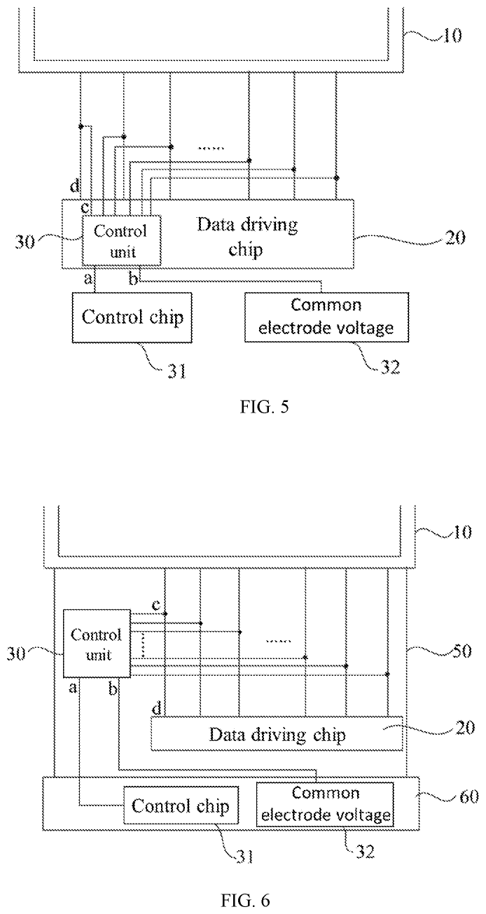

It is to be noted that, referring to FIG. 5, the control unit 30 in the embodiment of the present invention may be integrated in the data driving chip 20. In this solution, when the data driving chip 20 is manufactured, the control unit 30 is formed by the same process, such that an additional process of forming the control unit 30 is omitted. Also, since the control unit 30 is integrated in the data driving chip 20, space for disposing the control unit 30 is saved and the realization of a narrow frame is facilitated.

Furthermore, referring to FIG. 6, the display device provided in the embodiments of the present invention further comprises a chip on film 50. One end of the chip on film 50 is connected to the display panel 10. The data driving chip 20 and the control unit 30 are disposed on the chip on film 50. In this case, the control unit 30 may be directly disposed on the chip on film 50. In comparison with the control unit 30 disposed on the data driving chip 20, although an additional process is required, space for disposing the chip on film 50 is larger. Therefore, crosstalk of circuits between the control unit 30 and the data driving chip 20 may be prevented.

In the embodiments of the present invention, referring to FIG. 6, the display device further comprises a circuit board 60. The other end of the chip on film 50 is connected to the circuit board 60. The control chip 31 is disposed on the circuit board 60. The circuit board 60 may be a printed circuit board, and a timing controller and a power management integrated circuit may be disposed thereon (not shown in this figure). The timing controller may be used as the control chip 31, and the power management integrated circuit may be configured to provide the common electrode voltage 32. The circuit board 60 may also be a flexible circuit board, which is not limited herein.

It is to be noted that the above descriptions are only an example for demonstrating the specific structure of the display device, which eliminates the problem that the display panel flashes white during the shutdown of the display device. In fact, the specific structure of the display device is not limited by the above structures provided in the embodiments of the present invention, and may also be the other structures known to those skilled in the art.

The present invention further provides an electronic device, which comprises the display device mentioned in the above embodiments. The electronic device may be a smart phone, a tablet computer, a video player, a personal computer (PC), and so on, which is not limited herein.

Detailed above is the embodiments of the present invention. Although the principle and implementation of the present invention are described with reference to exemplary embodiments, the embodiments are only intended to help understand the technical solution and core idea of the present invention. In addition, those skilled in the art may still make modifications to the embodiments and applications based on the spirits of the present invention. That is to say, the descriptions herein should not be considered as limitations to the present invention.

What is claimed is:

1. A display device, comprising a display panel and a driver circuit, wherein the driver circuit is configured to drive the display panel, and the driver circuit comprises:
a data driving chip, which has a plurality of data signal output ends, and is configured to output a data signal to the display panel through the plurality of data signal output ends;
a control chip, which is configured to output a control signal when the display device is powered off; and
a control unit, which has a control end, an input end, and a plurality of output ends, wherein the control end is electrically connected to the control chip, the input end receives a common electrode voltage, and each of the output ends is connected to each of the data signal output ends; and
wherein the control unit is configured to output the common electrode voltage to the plurality of data signal output ends under a control of the control signal when the display device is powered off.

2. The display device according to claim 1, wherein the control unit comprises a plurality of transistors, each of the transistors is connected to each of the data signal output ends, a gate of each of the transistors is connected to the control end, a source of each of the transistors is connected to each of the data signal output ends, and a drain of each of the transistors is connected to the input end.

3. The display device according to claim 2, wherein all of the transistors are transistors of a same type.

4. The display device according to claim 2, having a normal display mode and a power-off mode;
wherein when the display device is under the normal display mode, the plurality of transistors are all turned off, and the data driving chip outputs the data signal to the display panel through the plurality of data signal output ends; and
wherein when the display device is under the power-off mode, the plurality of transistors are all turned on, and the common electrode voltage is outputted to the plurality of data signal output ends.

5. The display device according to claim 1, wherein the display panel comprises a plurality of data lines, and each of the data lines is connected to each of the data signal output ends.

6. The display device according to claim 5, wherein the display panel further comprises a plurality of scanning lines, the plurality of scanning lines and the plurality of data lines intersect each other to define a plurality of pixel units, each of the pixel units is electrically connected to a common electrode, and the common electrode is electrically connected to the input end.

7. The display device according to claim 1, wherein the control unit is integrated in the data driving chip.

8. The display device according to claim 1, further comprising a chip on film, wherein an end of the chip on film is connected to the display panel, and the data driving chip and the control unit are disposed on the chip on film.

9. The display device according to claim 8, further comprising a circuit board, wherein the other end of the chip on film is connected to the circuit board, and the control chip is disposed on the circuit board.

10. An electronic device, comprising a display device, wherein the display device comprises a display panel and a driver circuit, and the driver circuit is configured to drive the display panel and comprises:
a data driving chip, which has a plurality of data signal output ends, and is configured to output a data signal to the display panel through the plurality of data signal output ends;
a control chip, which is configured to output a control signal when the display device is powered off; and
a control unit, which has a control end, an input end, and a plurality of output ends, wherein the control end is electrically connected to the control chip, the input end receives a common electrode voltage, and each of the output ends is connected to each of the data signal output ends; and
wherein the control unit is configured to output the common electrode voltage to the plurality of data signal output ends under a control of the control signal when the display device is powered off.

11. The electronic device according to claim 10, wherein the control unit comprises a plurality of transistors, each of the transistors is connected to each of the data signal output ends, a gate of each of the transistors is connected to the control end, a source of each of the transistors is connected to each of the data signal output ends, and a drain of each of the transistors is connected to the input end.

12. The electronic device according to claim 11, wherein all of the transistors are transistors of a same type.

13. The electronic device according to claim 11, wherein the display device has a normal display mode and a power-off mode;
when the display device is under the normal display mode, the plurality of transistors are all turned off, and the data driving chip outputs the data signal to the display panel through the plurality of data signal output ends; and
when the display device is under the power-off mode, the plurality of transistors are all turned on, and the common electrode voltage is outputted to the plurality of data signal output ends.

14. The electronic device according to claim 10, wherein the display panel comprises a plurality of data lines, and each of the data lines is connected to each of the data signal output ends.

15. The electronic device according to claim 14, wherein the display panel further comprises a plurality of scanning lines, the plurality of scanning lines and the plurality of data lines intersect each other to define a plurality of pixel units, each of the pixel units is electrically connected to a common electrode, and the common electrode is electrically connected to the input end.

16. The electronic device according to claim 10, wherein the control unit is integrated in the data driving chip.

17. The electronic device according to claim 10, wherein the display device further comprises a chip on film, an end of the chip on film is connected to the display panel, and the data driving chip and the control unit are disposed on the chip on film.

18. The electronic device according to claim 17, wherein the display device further comprises a circuit board, the other end of the chip on film is connected to the circuit board, and the control chip is disposed on the circuit board.
